(19) United States
(12) Patent Application Publication
(10) Pub. No.: US 2010/0328394 A1
(43) Pub. Date: Dec. 30, 2010

(54) MULTIFUNCTIONAL PORTABLE DATA PROCESSING SYSTEM

(76) Inventors: Ying-Hui Huang, Taipei City (TW); Yung-Chuan Wu, Taoyuan County (TW)

Correspondence Address: Yung-Chuan Wu, 8f-3 No. 268, Section 2, Huan-Nan Rd., Ping-Jen City, 324, TW

(21) Appl. No.: 12/876,136

(22) Filed: Sep. 4, 2010

Related U.S. Application Data
(63) Continuation-in-part of application No. 11/792,698, filed on Jun. 8, 2007.
Application No. 11/792,698 is a continuation-in-part of application No. 11/793,356, filed on Jun. 14, 2007.

(51) Int. Cl. B41J 29/393

(52) U.S. Cl. 347/19

(57) ABSTRACT

A multifunctional portable data processing system having print, scan, and copy capabilities includes a portable computer having a housing, a display screen, a input panel, a pointing device, and a data processing unit which may be within or attached to the housing. The data processing unit includes a contact image sensor scan unit and a full page width ink jet printhead unit, an ink container, a paper path, paper feeding and ejecting rollers, control circuitry, and electrical power and standard data protocol data connections with the portable computer. The data processing unit further includes a clock with a clock rate fed to the printhead unit to reduce printing throughput of the printhead unit to approximately 1 to 60 pages per minute. The use of a stationary printhead unit and a reduced clock rate allows full functionality of the print system without sacrificing needed portability.

This application is a Continuation-in-Part of co-pending Application Ser. No. 11/792,698, filed on Jun. 8, 2007 and Ser. No. 11/793,356, filed on Jun. 14, 2007, the entire contents of which are hereby incorporated by reference.

### FIELD OF THE INVENTION

This invention relates to a portable data processing system. More specifically, a portable data processing system having a multifunctional, compact, light weight, and portable copy/print unit is disclosed.

### BACKGROUND OF THE INVENTION

Today's demands for increasing functionality, miniaturization, and portability are very apparent throughout the technological world. The advent of many kinds of portable computer products, for example, notebook computers, PDAs, cellular phones, digital cameras, and DVs has gone far toward meeting these goals. For example, notebook computers include a power supply which may include a battery and charging unit, CPU, data and power buses, a keyboard and a pointing device such as a touch pad, track ball, or joystick to facilitate data input, and a liquid crystal display (LCD) panel for viewing the inputted data. Higher-level notebook computers also commonly include a CD/DVD drive and various attachments allowing exchange of data over a wired or wireless network.

Although these characteristics accommodate most user needs, obviously there are times when digitized data is not enough and access to a printer or scanner becomes a necessity. Currently, accessing a printer or scanner generally involves connecting to a network, which in turn, is connected to the needed device, or taking the portable computer product to a location having a printer or scanner and making the appropriate connections. While this solution is practical and inexpensive due to the sharing of resources, this same solution severely limits portability of a computer system having multifunctional (print and scan) capabilities because generally, due to size, weight, power requirements, and other factors, neither the network nor the multifunctional device can reasonably be considered portable.

Commonly today, users prefer non-impact printers and may choose between a laser printer and an ink jet printer. Laser printers are generally fast, produce good results, and are expensive. Much of the size and expense of laser printers revolve around the necessity of creating static charges and heat to place and bond the dry ink (toner) onto the paper. On the other hand, ink jet printers utilize liquid ink that is sprayed in tiny droplets onto the paper via either thermal bubble or piezoelectric technologies. Generally ink jet printers utilize a stepper motor to move a small, movable printhead back and forth across the width of the paper with each round trip of the printhead producing one or two lines of print on the paper. The stepper motor, moving print cartridge and associated belt, and stabilizing bar required to ensure precise movement control all serve to prevent miniaturization and therefore portability.

One additional type of ink jet printer that was developed for very high speed printing (300-400 ppm) is disclosed in U.S. Pat. No. 4,559,543 issued to Toganoh, et al. and incorporated herein by reference. The disclosure utilizes a plurality of smaller printheads juxtaposed on a circuit board so that the combination of all the printheads form a full-width printhead unit capable of printing an entire line at one time. While eliminating the problems associated with a moving print cartridge, the disclosed very high speed system obviously requires large ink supplies, a very precise paper feeding system, and systems to dry the ink as well as prevent the system from overheating, again, making the disclosed device unpractical for a mobile system.

Amongst scanners, users generally prefer flatbed scanners where a document to be scanned remains stationary. A scanning module having a cold cathode light source moves across the document and utilizes an assortment of mirrors and a lens to redirect and focus light reflected off of the document to and on an array of charge coupled device (CCD) sensors. This type of scanner is well known and further detail will be omitted. However, the moving scanner module and associated motor and linkages also serve to prevent miniaturization and therefore portability.

Another type of known scanner utilizes a light guide to distribute light emitted from one or more LEDs across a document and the light reflected off of the document is directly sensed by an array of sensors located near the surface of the document. This type of scanning system is known as a contact image sensor (CIS). Some CIS scanners use CCFLs instead of LEDs as their light sources. One non-limiting example of such CIS scanners is disclosed in U.S. Pat. No. 6,744,543, issued to Keithley, also incorporated herein by reference. HP's Scanjet 4600/4670 scanners are also examples of CIS type scanners, wherein a long narrow stripe shape mirror is used to simply redirect the light to miniaturize the CIS module.

However, the size, weight, and power requirements of any of the known types of printers and scanners prevent them from being part of a completely portable data processing system.

### SUMMARY OF THE INVENTION

The claimed invention discloses a truly a portable data processing system having multifunctional capabilities including scanning, printing, and copying, overcoming size, weight, and power requirements of known systems.

A data processing system according to the claimed invention includes a portable computer having a housing, a display screen, an input panel, a pointing device, and a data processing unit. The data processing unit may be within or physically connected to the housing of the portable computer. The data processing unit includes a print system having an ink container, a full page width ink jet printhead unit, a paper path, feeding and ejecting rollers, a motor, control circuitry, and electrical power and standard data protocol data connections with the portable computer. The printhead unit may utilize either a thermal bubble or a piezoelectric technology. The data processing unit also includes a scan unit having a contact image sensor disposed along the paper path or possibly along a second paper path. According to signals received from the portable computer, the scan unit can generate a digitized image of a document fed through the paper path. The digitized image may be stored in a memory of the portable computer. When a digitized image is to be printed, the control signals from the portable computer cause the printhead unit to receive ink from the ink container and spray ink onto a paper moving within the paper path in a pattern determined by print data received from the portable computer, one full line at a time. Sequential or simultaneous use (possible when a second paper path is provided) of the scan unit and the print unit permits the portable computer to enjoy full multifunctional capabilities of scanning, printing, and copying while retaining highly portable characteristics. Of course, the scan unit and print unit can be driven independently by the portable computer as a scanner or printer.

These and other objectives of the claimed invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a side view diagram of a data processing system according to the present invention.

FIG. 2 is a functional block diagram of a data processing unit or the data processing system of FIG. 1.

FIG. 3 is diagram of a top view of the data processing system of FIG. 1.

FIG. 4 is a partial cutaway, top view of another data processing system according to the present invention.

FIG. 5 is a block diagram of another data processing system according to the present invention.

FIG. 6 is a top view of another data processing system according to the present invention.

FIG. 7 is a partial cutaway, top view of another data processing system according to the present invention.

FIG. 8 is a functional block diagram of another data processing unit or the data processing system of FIG. 1.

FIG. 9 is a schematically illustration showing the printhead unit having juxtaposed ink jet units each having a printhead connected to the ink container.

### DETAILED DESCRIPTION OF THE INVENTION

In the following description, we use a notebook computer as an example of a portable computer, but for the skilled person in the art, it should be easy to understand how to apply the present invention to the other kinds of portable computer products.

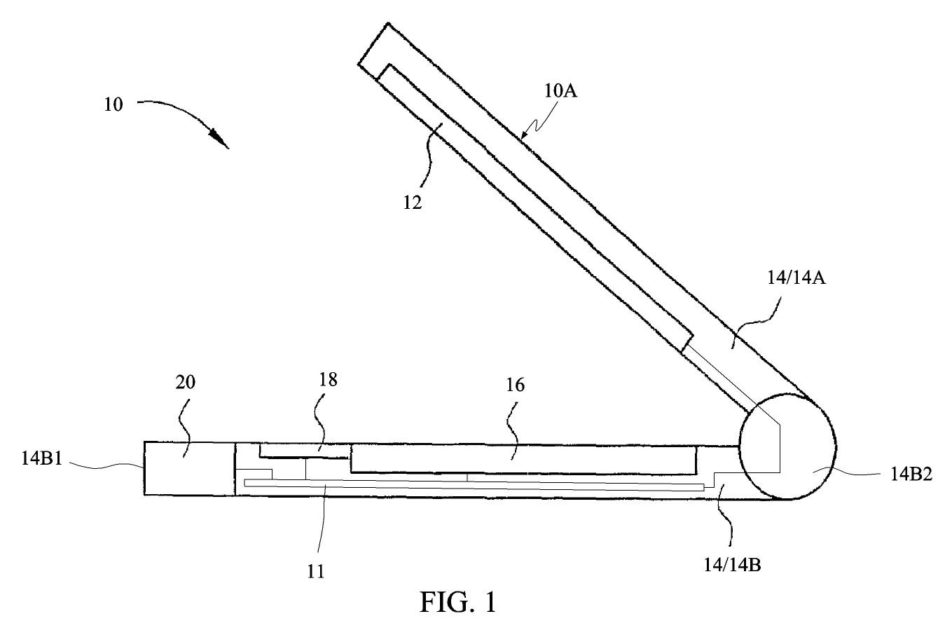

FIG. 1 is a side view diagram of a portable data processing system 10 according to the present invention. The data processing system 10 comprises a notebook computer (portable computer) 10A having a housing 14, a motherboard 11 disposed in the housing 14, and a display screen 12, a keyboard 16, a pointing device 18 and a data processing unit 20, all of which are electrically connected to the motherboard 11. The housing 14 includes two parts 14A and 14B. In this embodiment, the two parts 14A and 14B are connected together, and pivotally connected to each other. The display 12 is disposed in the first part 14A, the keyboard 16 and the pointing device 18 are disposed in the second part 14B, and the data processing unit 20 is connected to the second part 14B and electrically connected to the portable computer. The data processing unit 20 is disposed near a first side 14B1 of the second part 14B and away from a connection portion 14B2 between the second part 14B and the first part 14A. The data processing system 10 may also comprise a battery, CPU, memory, hard drive, control circuitry, and other components commonly found in a notebook computer. The display screen 12 preferably is a liquid crystal display (LCD). The pointing device may be a touch screen, track ball, joystick, or any other device capable of controlling cursor movement.

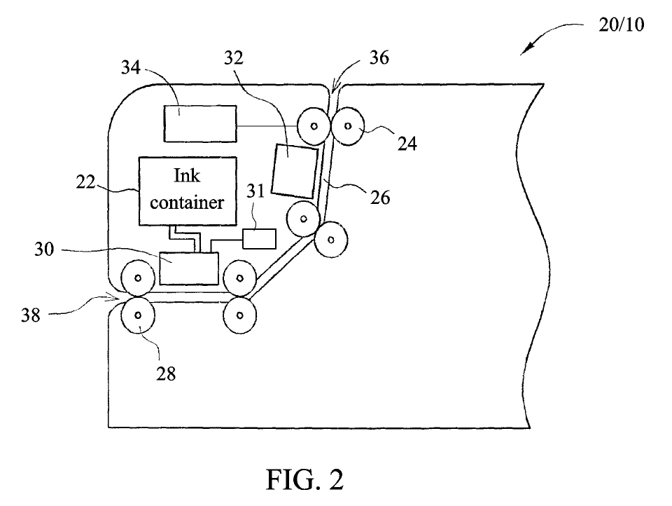

The key to the present invention is the data processing unit 20. To retain the desired portability of the data processing system 10, the novel data processing unit 20 has been devised which minimizes size and weight while retaining full functionality. Please refer to FIG. 2, which is a functional block side view diagram of the data processing unit 20 or data processing system 10.

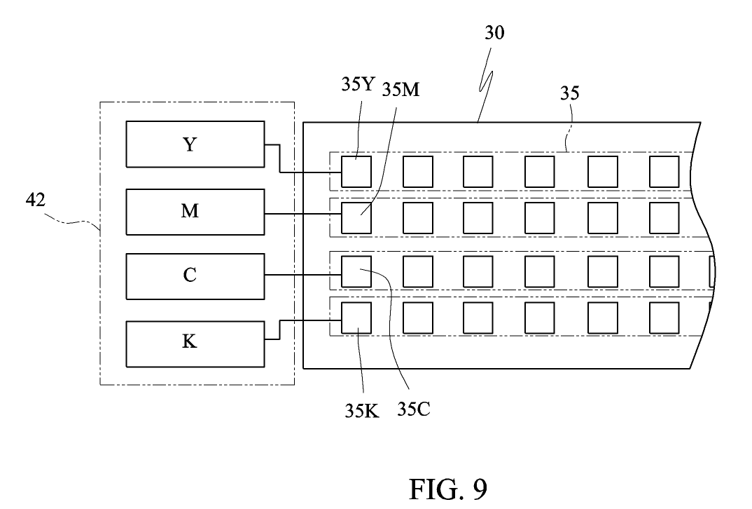

It is to be noted that a clock 31 may be disposed in the data processing unit 20 or the data processing system 10. When the clock 31 is disposed outside the data processing unit 20, the clock 31 may be disposed in the portable computer 10A. The data processing unit 20 comprises an ink container 22 attached to a printhead unit 30, which may be a full page width ink jet printhead unit, which has juxtaposed ink jet units 35 each having one or more than one printhead 35C/35M/35Y/35K connected to the ink container 22, as shown in FIG. 9. The ink container 22 may contain one or as many colors of ink as desired according to design considerations. The ink container 22 may be disposed adjacent to one end of the printhead unit 30 or above the printhead unit 30. Near the printhead unit 30 is a paper path 26 for allowing paper to move in front of the printhead unit 30 and receive predetermined ink. The paper path 26 includes a paper feeding slot 36 and a paper release slot 38 at opposite ends of the paper path 26, which is preferably but not necessarily curved to save room. A feeding roller set 24 and an ejecting roller set 28, which constitutes a paper conveying mechanism for conveying paper across the printhead unit 30, are disposed along the paper path 26 near the paper feed slot 36 and the paper release slot 38 respectively to provide and ensure proper movement of a paper within the paper path 26. A stepping motor 34 may be connected to one or more of the roller sets 24, 28 for providing controlled movement of the paper. The data processing unit 20 may further comprises a scan unit 32 disposed along the paper path 26 for generating a digital image of a document passing through the paper path 26. In this case, the paper conveying mechanism further conveys paper across the scan unit 32. Thus, the data processing unit 20 without the scan unit 32 may also be referred to as a print unit. The data processing unit 20 additionally requires control circuitry and electrical and data/signal connections with the notebook computer of the data processing system 10 and connections between comprised control circuitry, the motor 34, and the printhead unit 30 and the notebook computer of the data processing system 10. The control circuitry may be located within the data processing unit 20 or within the notebook computer. The portable computer may operate the data processing unit 20 according to signals transmitted from the portable computer to the data processing unit 20, wherein the signals can be passed to the data processing unit 20 from the notebook computer by any standard form of protocol such as USB, PCMCIA, IDE, IEEE 1284, or IEEE 1794 to name 5 non-limiting examples. Electrical power is preferably provided to the data processing unit 20 by the data processing system 10, however it may be possible to obtain power from an external source when needed. The data processing unit 20 may be formed within a portion of the housing 14, or it may be detachably physically connected to the housing 14 through a connecting device such as arms, clips, clamps, screws, or the like. Whether integrally formed or connected, the data processing system 10 is intended to be a portable, single unit.

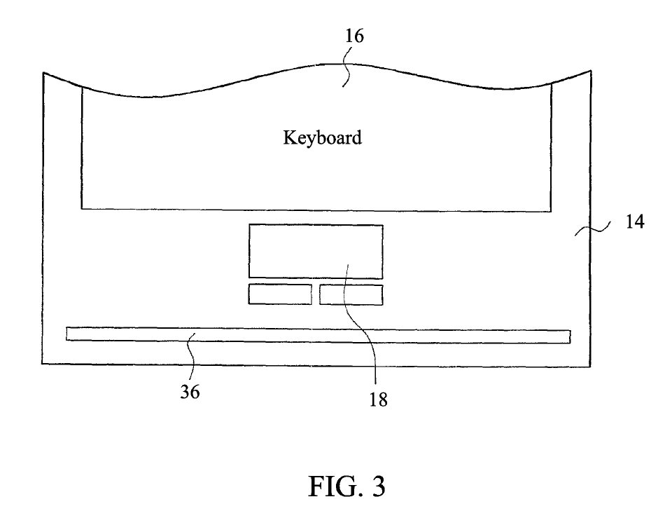

FIG. 3 illustrates a top view of one embodiment of the data processing system 10 having the data processing unit 20 within the housing 14 of a notebook computer. FIG. 3 indicates a possible arrangement of the keyboard 16, pointing device 18 and the paper feed slot 36 of the data processing unit 20.

The present invention utilizes the full page width ink jet printhead unit 30 to avoid previously discussed size and weight restrictions caused by movable print cartridges. The printhead unit 30 may be integrally formed of a plurality of ink jet nozzles so that a total width (in the longest direction) of the printhead unit 30 is preferably about the width of a letter or A4 sized piece of paper. Another embodiment of the present invention utilizes a plurality of smaller ink jet units each comprising a printhead unit having ink jet nozzles, with the ink jet units aligned next to each other on a circuit board or other surface so that in combination they form a printhead unit 30 of approximately the same width. According to signals received from the control circuitry, the printhead unit 30 receives ink from ink container 22 and, utilizing either a thermal bubble or a piezoelectric technology, sprays ink onto a paper moving within the paper path 26 in a pattern determined by the print data received from the notebook computer of the data processing system 10, one full line at a time.

Because the data processing system 10 is designed to be as portable as possible, and because most notebook computers are battery operated, substantial space, cost, and power savings can be saved through modifications removing the necessity of components normally considered essential to a printing system. For example, the data processing unit 20 utilizes a relatively slow clock rate which is fed from the clock 31 to the printhead unit 30 to reduce the printing throughput of the printhead unit 30 to a lower printing capacity, thus providing the ability to print a small number of documents per minute, perhaps less than 60 (it's a relatively very slow printing speed compared to the application disclosed in the foresaid patent), providing several advantages. Traditionally, the full page width ink jet printhead unit has maximum printing throughput higher than 200 ppm by giving a very high-speed clock rate, wherein the ppm is generally defined under the print conditions of A4-sized printed papers with 5% coverage rate and under the monochrome mode. One direct advantage is that a slower clock rate effectively does away with heating problems and eliminates the prior art printing system's need for cooling and ink drying devices, at a substantial savings in power consumption, cost, and space. Additionally and with similar results, paper trays, such as the supply and discharge trays, and complicated paper feeding systems, such as the pick-up roller, the separation roller or the separation pad, are no longer needed. For example, when a user wishes to print a document, a single piece of paper may be inserted into the paper feed slot 36 where the motor 34 drives the feeding roller set 24 and the ejecting roller set 28 to guide the inserted paper across the printhead unit 30 in a timely fashion.

The reduced printing capability implemented by the clock with the relatively slow clock rate is a key issue of this invention. The relatively slow clock rate was not used in the prior art because the designers of full page width ink jet printer tried to increase the printing throughput as possible as they can so that the machine with the high printing throughput (e.g., 300-400 ppm) has the complicated mechanisms and needs the high power supply. The object of this invention is to provide the compact size product. To achieve this object, the applicants have found that reducing the printing throughput using the clock with the relatively slow clock rate is required. Although U.S. Pat. No. 5,400,062 (hereinafter, the “'062 patent”) has disclosed that the presence of white space on a page and the use of EOL characters can improve the average throughput rate beyond 10 ppm, the 10 ppm printing speed is merely an result but is not a means to simplify the mechanism design and eliminate the requirement of the high power supply. This invention makes the full page width printhead normally work in a compact sized portable computer system by eliminating the complicated mechanisms and the high power supply, and the eliminating of the complicated mechanisms and the high power supply has to be achieved by the reduced printing throughput. The '062 patent never discloses the relationships between the reduced printing throughput, the complicated mechanisms and the high power supply. In fact, the '062 patent is an irrelevant art to the full page width printhead. Thus, not prior art has taught, motivated or suggested to suppress the complicated mechanisms and the high power supply by sacrificing the printing throughput of the full page width printhead. This is because the main feature of the full page width printhead is the high-speed printing and the products with the full page width printheads continuously increase their printing speeds. Thus, reducing the printing throughput of the full page width printhead disobeys the mainstream application thereof.

The present invention also utilizes a sheet fed scan unit 32 for generating a digital image of a document passing through the paper path 26. The scan unit 32 comprises a light guide device for guiding and diffusing light emitted by one or more LEDs to a document to be scanned. A full page width contact image sensor (CIS) receives the light reflected from the document for generating the digital image. The digital image is preferably, but not necessarily stored in the memory of the notebook computer. The use of a CIS in the scan unit 32 aids in the compactness of the data processing system 10 by eliminating the need of a prior art moveable scan unit and associated mirrors. Additionally, a CIS is relatively power efficient, allowing the battery of the notebook computer to provide all power requirements without excessive drain on the battery.

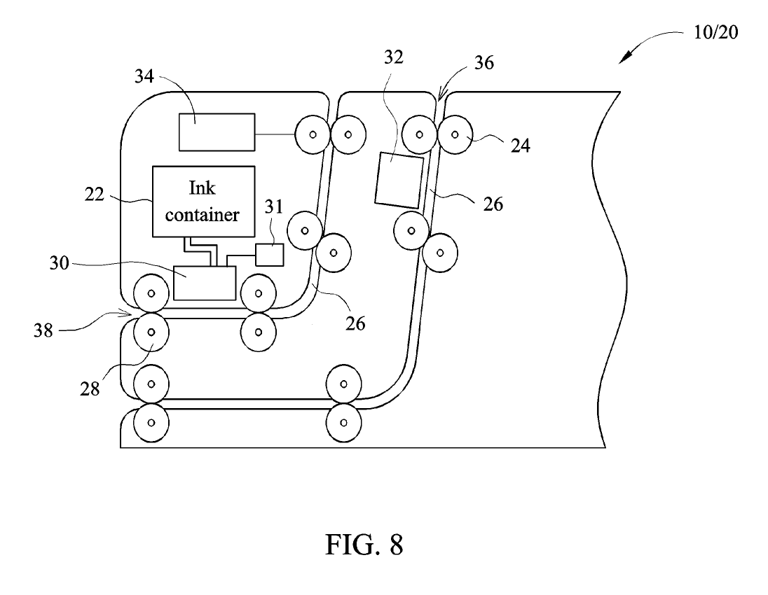

While only a single paper path 26 is necessary to achieve full functionality of the data processing unit 20, another embodiment of the present invention comprises at least all of the components of the previous embodiments with the addition of a second paper path 26 as illustrated in FIG. 8. Here, the first paper path 26 is directed in front of the scan unit 32 and the second paper path 26 is directed in front of the printhead unit 30. This arrangement allows the insertion by a user of a document to be scanned into the first paper path 26 and a clean sheet of paper into the second paper path 26 so that a copy of the original document can be printed quicker.

Data and commands can be passed between the data processing unit 20 and the notebook computer by any standard form of protocol such as USB, PCMCIA, IDE, IEEE 1284, or IEEE 1794 to name 5 non-limiting examples. Electrical power is preferably provided to the data processing unit 20 by the notebook computer, however it may be possible to obtain power from an external source when needed. Additionally, if the notebook computer has access to a telephone network, the data processing unit 20 in combination with the notebook computer may be utilized to send or receive faxes.

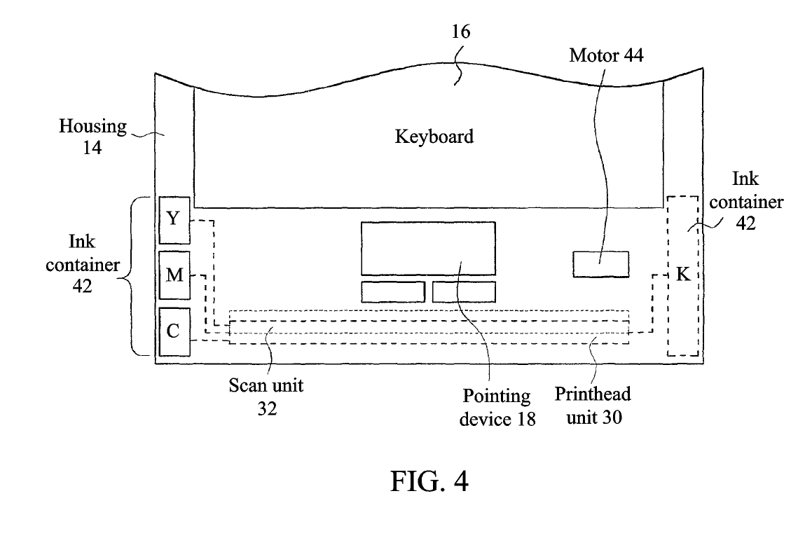

FIG. 4 illustrates a partial cutaway, top view of an embodiment having a specialized arrangement of 4 ink containers 42, although the present invention is not to be limited by this arrangement or number of ink containers. The embodiment shown in FIG. 4 includes the keyboard 16, housing 14, pointing device 18, scan unit 32, motor 44, and the printhead unit 30 of the former embodiments. Of particular note in this figure is a normal width relationship between the housing 14 and the printhead and scan units 30, 32. As shown in FIG. 4, the housing 14 of most notebook computers is wider than the width required for the claimed data processing unit 20 as well as the full page width ink jet printhead unit 30. Because areas at the ends of the printhead unit 30 are not needed for stopping a prior art movable print cartridge as the printhead unit of the present invention remains stationary, the areas at the two ends of the printhead unit 30 can be utilized to efficiently house the ink containers 42. FIG. 4 illustrates one such possible configuration comprising Yellow (Y), Magenta (M), Cyan (C), and Black (K) in ink containers 42 at the ends of, and connected to, the printhead unit 30, permitting the thickness of the data processing system 10 to be further reduced.

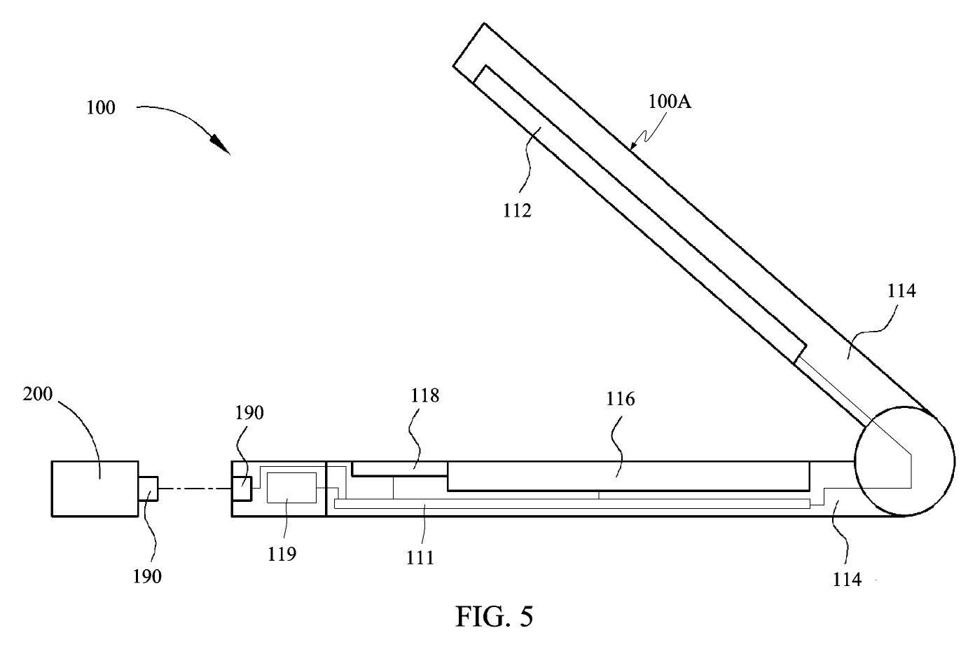

FIG. 5 is a block diagram of another data processing system 100 according to the present invention. The data processing system 100 comprises a notebook computer 100A having a housing 114, a display 112, a keyboard 116, a pointing device 118, a power supply 119 and a data processing unit 200. The data processing unit 200 is directly electrically connected to the power supply 119 or electronically connected to the power supply 119 through the motherboard 111 to receive electrical power from the portable computer. The data processing unit 200 comprises all of the components of the data processing unit 20. All components of the data processing system 100 function similarly to the components of the data processing system 10 so further elaboration is omitted. The difference between the present embodiment and the data processing system 10 is that the data processing unit 200 of the present embodiment is detachable from the housing 114 of the notebook computer as shown in FIG. 5. To provide full functionality of the data processing system 100, both the data processing unit 200 and the housing 114 comprise a connecting device 190 for physically and electrically connecting the data processing unit 200 to the housing 114 of the notebook computer. The connecting device 190 may be one or more reciprocating male/female sockets, arms, clips, clamps, screws, or the like according to design considerations. What is important about the connecting device 190 is that the connecting device 190 physical connects the data processing unit 200 with the housing 114 of the notebook computer so that the combination can be easily transported as a single, integrated unit. Several variations of the physical arrangements of the various components of the connecting device or connector 190 would be readily apparent to one skilled in the art without exceeding the scope of the present invention.

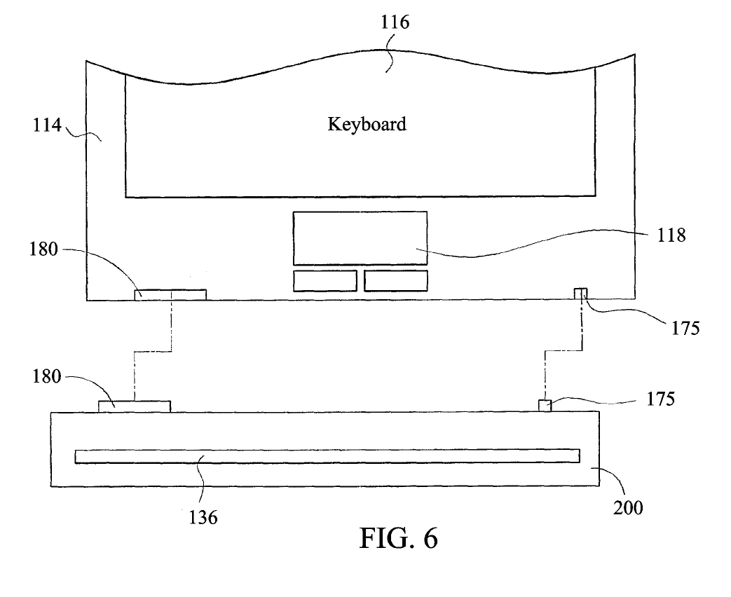

FIG. 6 is a top view of the data processing system 200 showing one possible arrangement of the electrical and data connections between the data processing unit 200 and the notebook computer. Aside from the physical connecting device 190, the data processing unit 200 and the notebook computer comprise at least one data bus, shown as signal connector 180, and at least one power connector 175. The power connector 175 may connect the data processing unit 200 with a power source within the housing 114 or optionally to an external source such as a conventional electrical wall socket. The signal connector 180 for transmitting signals to or receiving signals from an external computer system provides a path for control communications between the control circuitry of the notebook computer and the data processing unit 200. The signal connector 180 additionally provides a data path for transferring a digital image from the scan unit 32 to the memory of the notebook computer and/or from the memory of the notebook computer to the printhead unit 30. The signal connector 180 may utilize a wired or wireless communication protocol. The power connector connects the active power source of the notebook computer with the data processing unit 200 providing electrical power to the data processing unit 200. The active power source of the notebook computer may be the battery or other source of power within the notebook computer.

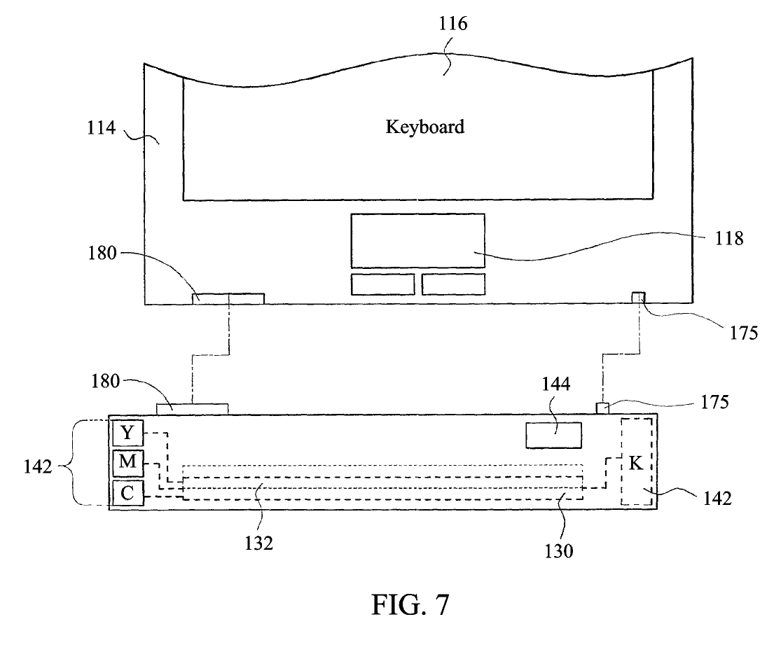

FIG. 7 is a partial cutaway, top view of another data processing system similar to that shown in FIGS. 5 and 6. The difference between the embodiment shown in FIG. 7 and the data processing system 200 is that the current embodiment has an arrangement of ink containers 142 similar to that shown in FIG. 4. Additionally illustrated is a printhead unit 130 that is structurally and functionally akin to the printhead unit 30 and a scan unit 132 that is structurally and functionally akin to the scan unit 32. An ink container 142 is connected to the printhead unit 130 preferrably in an arrangement similar to that of FIG. 4. Also shown are the motor 144 that drives feeding and/or ejecting roller sets 24, 28 and the relative location of the paper feed slot 136 (see FIG. 6).

In another embodiment, it may be possible to remove the need for physical, data, and electrical connections between the data processing unit 200 and the notebook computer. Such an arrangement would appear similar to the data processing unit 200 in FIG. 6, only optionally without the connectors 175, 180, 190. This embodiment at least requires additional internal circuitry, a microprocessor, memory, and a power source, be it a battery or a device for connecting with an external power source. However, the use of the full page width ink jet printhead unit 30 and the sheet fed contact image sensor (CIS) scan unit 32 produce a tightly compact data processing unit, or portable data processing module as it may be termed, that is smaller, more portable, and more energy efficient than is available in the market today. In another embodiment, the portable data processing module includes the full page width ink jet printhead unit, the clock, at least one ink container and a paper conveying mechanism, and may further optionally include the scan unit. The portable data processing module may optionally comprise I/O terminals for a standard protocol such as USB, PCMCIA, IDE, IEEE 1284, or IEEE 1794 to name 5 non-limiting examples so that data and/or commands can be passed between the data processing unit 200 and almost any kind of computer system. The portable data processing module optionally may additionally comprise standard wireless or wired network protocol connections for interfacing with and exchanging digital image data with a computer system via a network. Examples of such wireless network protocols include but are not limited to IEEE 802.11, IEEE 802.11a, IEEE 802.11b, IEEE 802.11g, and Bluetooth.

In contrast to prior art, the present application discloses a novel portable, multifunctional data processing system that includes print, scan, and copy capabilities. Previously, it was not practical to incorporate multifunctional capabilities or print capabilities into a portable data processing system due to size, weight, and power considerations. The present invention has eliminated those problems by creatively applying the use of a full page width ink jet printhead having a bare minimum of components with a notebook computer to form a truly a portable data processing system. Also, the present invention has eliminated those problems by creatively applying the use of a full page width ink jet printhead and a CIS scan unit with a notebook computer to form a truly a portable data processing system. Those skilled in the art will readily observe that numerous modifications and alterations of the device and method may be made while retaining the teachings of the invention. Accordingly, the above disclosure should be construed as limited only by the metes and bounds of the appended claims.

1. A multifunctional portable data processing system comprising:
a portable computer with a housing;
a data processing unit connected to the housing and electrically connected to the portable computer, the data processing unit comprising a full page width ink jet printhead unit;
a clock with a clock rate fed to the full page width ink jet printhead unit to reduce printing throughput of the full page width ink jet printhead unit to approximately 1 to 60 pages per minute; and
a paper conveying mechanism for conveying paper across the printhead unit; and
at least one ink container connected to the printhead unit.

2. The multifunctional portable data processing system of claim 1, wherein the portable computer operates the data processing unit according to signals transmitted from the portable computer to the data processing unit.

3. The multifunctional portable data processing system of claim 1 wherein the at least one ink container is disposed adjacent to one end of the printhead unit or above the printhead unit.

4. The multifunctional portable data processing system of claim 1, wherein the data processing unit further comprises a contact image sensor scan unit, and the paper conveying mechanism further conveys paper across the scan unit.

5. The multifunctional portable data processing system of claim 4 wherein the paper conveying mechanism comprises a first paper path for guiding paper across the printhead unit and a second paper path for guiding paper across the scan unit.

6. The multifunctional portable data processing system of claim 1 wherein the full page width ink jet printhead unit has maximum printing throughput higher than 200 ppm.

7. The multifunctional portable data processing system of claim 1 wherein the data processing unit is detachably physically connected to the housing.

8. The multifunctional portable data processing system of claim 7 wherein the data processing unit is electrically connected to a power supply of the portable computer to receive electrical power from the portable computer.

9. The multifunctional portable data processing system of claim 7 wherein the printhead unit comprises a plurality of juxtaposed ink jet units each having a printhead connected to the ink container.

10. The multifunctional portable data processing system of claim 7 wherein the paper conveying mechanism comprises a first paper path for guiding paper across the printhead unit and a second paper path for guiding paper across the scan unit.

11. A portable data processing module comprising:
a full page width ink jet printhead unit;
a clock with a clock rate fed to the full page width ink jet printhead unit to reduce printing throughput of the full page width ink jet printhead unit to approximately 1 to 60 pages per minute;
at least one ink container connected to the printhead unit; and
a paper conveying mechanism for conveying paper across the printhead unit.

12. The portable data processing module of claim 11 wherein the printhead unit comprises a plurality of juxtaposed ink jet units each having a printhead connected to the ink container.

13. The portable data processing module of claim 11 wherein the at least one ink container is disposed adjacent to one end of the printhead unit or above the printhead unit.

14. The portable data processing module of claim 11 further comprising a signal connector transmitting signals to or receiving signals from an external computer system.

15. The portable data processing module of claim 11 further comprising a contact image sensor scan unit, and the paper conveying mechanism further conveys paper across the scan unit.

16. The portable data processing module of claim 15 wherein the paper conveying mechanism comprises a first paper path for guiding paper across the printhead unit and a second paper path for guiding paper across the scan unit.

17. The portable data processing module of claim 11 wherein the full page width ink jet printhead unit has maximum printing throughput higher than 200 ppm.
